(19) United States
(12) Patent Application Publication
(10) Pub. No.: US 2025/0201021 A1
(43) Pub. Date: Jun. 19, 2025

(54) DEVICE AND METHOD OF RECOGNIZING FACIAL EXPRESSION OF VEHICLE OCCUPANT

(71) Applicants: Hyundai Motor Company, Seoul (KR); Kia Corporation, Seoul (KR); Hankuk University OF Foreign Studies Research & Business Foundation, Yongin-si (KR)

(72) Inventors: Kangin LEE, Hwaseong-Si (KR); Yonggwon JEON, Hwaseong-Si (KR); JeeEun LEE, Hwaseong-Si (KR); JaeYoung CHOI, Gwacheon-Si (KR); KyeongTae KIM, Yongin-si (KR)

(73) Assignees: Hyundai Motor Company, Seoul (KR); Kia Corporation, Seoul (KR); Hankuk University OF Foreign Studies Research & Business Foundation, Yongin-si (KR)

(21) Appl. No.: 18/908,443

(22) Filed: Oct. 7, 2024

(30) Foreign Application Priority Data
Dec. 13, 2023 (KR) 10-2023-0180920

(51) Int. Cl. G06V 40/16; G06T 7/11; G06V 10/40; G06V 10/80; G06V 10/82

(52) U.S. Cl. CPC G06V 40/175; G06T 7/11; G06V 10/40; G06V 10/806; G06V 10/82

(57) ABSTRACT

A device prepares an input image including a facial region to perform facial expression recognition of a vehicle occupant, inputs the input image to a first neural network including basic modules including a residual block, applies a second neural network to the output of the first neural network to extract first-level features and segment the output of the first neural network into local regions, applies a third neural network to each of local regions to extract second-level features, segments the output of the first neural network into patch regions greater than the number of local regions, and applies a fourth neural network to each of the patch regions to extract third-level features, and combines and concatenates at least some of the first-level, second-level, and third-level features, input the concatenated and combined features to a classifier, and classify an emotion through the classifier.

### CROSS-REFERENCE TO RELATED APPLICATION

The present application claims priority to Korean Patent Application No. 10-2023-0180920 filed on Dec. 13, 2023, the entire contents of which is incorporated herein for all purposes by this reference.

### BACKGROUND OF THE PRESENT DISCLOSURE

### Field of the Present Disclosure

The present disclosure relates to a device and a method of recognizing a facial expression of a vehicle occupant.

### Description of Related art

Facial expression recognition technology may be used to analyze a person's facial expression to determine his or her emotional state. Facial expression recognition technology is evolving significantly with the development in artificial intelligence fields and computer vision fields, for example, a convolutional neural network (CNN) is used to extract and separate facial features to identify visual features of the face and recognize facial expressions. Alternatively, recurrent neural networks (RNNs) and long short-term memory (LSTMs) may be used to analyze facial expression changes in a video or consecutive image sequences. Sometimes, to recognize facial expressions, a method of extracting facial landmarks and recognizing facial expressions based on the extracted facial landmarks may be used. In the present context, extracting facial landmarks may mean finding important points such as eyes, nose, mouth, and jawline, in a facial image. Then, based on the extracted facial landmarks, facial expressions may be analyzed and emotional states may be identified. However, the method of extracting facial landmarks has difficulties in recognizing facial expressions of details that are difficult to represent as landmarks on the face or that are not defined as landmarks.

The information included in this Background of the present disclosure is only for enhancement of understanding of the general background of the present disclosure and may not be taken as an acknowledgement or any form of suggestion that this information forms the prior art already known to a person skilled in the art.

### BRIEF SUMMARY

Various aspects of the present disclosure are directed to providing a device and a method of recognizing a facial expression of a vehicle occupant, which are configured for recognizing even partial and fine facial expressions to improve emotion classification performance.

An exemplary embodiment of the present disclosure provides a device for recognizing a facial expression of a vehicle occupant, the device including: one or more processors and one or more memory devices, in which the one or more memory devices include a program code, and the program code is executed by the one or more processors to prepare an input image including a facial region to perform facial expression recognition of a vehicle occupant, input the input image to a first neural network including a plurality of basic modules including a residual block to obtain an output of the first neural network, apply a second neural network to the output of the first neural network to extract first-level features, segment the output of the first neural network into a plurality of local regions, and apply a third neural network to each of the local regions to extract a plurality of second-level features, segment the output of the first neural network into a plurality of patch regions greater than the number of local regions, and apply a fourth neural network to each of the patch regions to extract third-level features, perform feature combination by selecting features corresponding to a top certain percentage of the first-level features including high classification confidence values, perform feature combination by selecting features corresponding to a top certain percentage of the second-level features including high classification confidence values, select features corresponding to a top certain percentage of the third-level features including high classification confidence values and concatenating the selected features, and concatenate the selected and concatenated features of the first-level features, the selected and concatenated features of the second-level features, and the selected and concatenated features of the third-level features, input the concatenated features to a classifier, and classify an emotion through the classifier.

In some exemplary embodiments of the present disclosure, the features selected from the first-level features and the features selected from the second-level features may be provided as input to the fourth neural network.

In some exemplary embodiments of the present disclosure, the first neural network may include an initial layer, and the plurality of residual blocks following the initial layer, and the one residual block may include two the basic modules.

In some exemplary embodiments of the present disclosure, the second neural network may include a multi-scale module including a plurality of multi-scale blocks including filters of different sizes.

In some exemplary embodiments of the present disclosure, the third neural network may include a convolutional block attention module (CBAM) that includes a channel attention module and a spatial attention module, and sequentially applies the channel attention module and the spatial attention module.

In some exemplary embodiments of the present disclosure, the fourth neural network may include a patch attention module including a first basic module, a second basic module, a first CBAM, and a second CBAM which are sequentially connected.

In some exemplary embodiments of the present disclosure, the first basic module may be implemented as 3×3 convolution and 64 filter, the second basic module may be implemented as 3×3 convolution and 128 filter, the first CBAM may be implemented as 3×3 convolution and 256 filter, and the second CBAM may have 3×3 convolution and 512 filter.

In some exemplary embodiments of the present disclosure, the segmenting of the output of the first neural network into the plurality of patch regions may include: performing up-sampling by applying a pixel shuffle to the output of the first neural network; and segmenting the up-sampled output into the plurality of patch regions.

In some exemplary embodiments of the present disclosure, features corresponding to a bottom certain percentage of the first-level features to the third-level features including low classification confidence values may be used as mean squared error (MSE) loss.

In some exemplary embodiments of the present disclosure, the concatenation of the first-level features and the second-level features may include inputting each of the first-level features and the second-level features into a graph convolutional network (GCN) combiner, to perform feature combination.

In some exemplary embodiments of the present disclosure, the preparing of the input image including the facial region may include: obtaining an image from a camera capturing a vehicle occupant; detecting a facial region to perform facial expression recognition in the image; aligning the detected facial region; and preparing a result of the aligning as the input image.

Another exemplary embodiment of the present disclosure provides a device for recognizing a facial expression of a vehicle occupant, the device including: one or more processors and one or more memory devices, in which the one or more memory devices include a program code, and the program code is executed by the one or more processors to prepare an input image including a facial region to perform facial expression recognition of a vehicle occupant, input the input image to a first neural network including a plurality of basic modules including a residual block to obtain an output of the first neural network, apply a second neural network to the output of the first neural network to extract first-level features, segment the output of the first neural network into a plurality of local regions, and apply a third neural network to each of the local regions to extract a plurality of second-level features, segment the output of the first neural network into a plurality of patch regions greater than the number of local regions, and apply a fourth neural network to each of the patch regions to extract third-level features, inactivate at least some of the first-level features, the second-level features, and the third-level features for facial expression recognition, and combine and concatenate the remaining portion of non-inactivated features, input the combined and concatenated features to a classifier, and classify an emotion through the classifier.

In some exemplary embodiments of the present disclosure, the classifying of the emotion may include selecting features corresponding to a top certain percentage of features of the remaining portion of features including high classification confidence values, performing feature combination on the selected features or concatenating the selected features, inputting the combined or concatenated features to the classifier, and classify the emotion.

In some exemplary embodiments of the present disclosure, the first neural network may include an initial layer, and the plurality of residual blocks following the initial layer, and the one residual block may include two the basic modules.

In some exemplary embodiments of the present disclosure, the second neural network may include a multi-scale module including a plurality of multi-scale blocks including filters of different sizes.

In some exemplary embodiments of the present disclosure, the third neural network may include a convolutional block attention module (CBAM) that includes a channel attention module and a spatial attention module, and sequentially applies the channel attention module and the spatial attention module.

In some exemplary embodiments of the present disclosure, the fourth neural network may include a patch attention module including a first basic module, a second basic module, a first CBAM, and a second CBAM which are sequentially connected.

Yet another exemplary embodiment of the present disclosure provides a method of recognizing a facial expression of a vehicle occupant, the method including: preparing an input image including a facial region to perform facial expression recognition of a vehicle occupant; inputting the input image to a first neural network including a plurality of basic modules including a residual block to obtain an output of the first neural network; applying a second neural network to the output of the first neural network to extract first-level features; segmenting the output of the first neural network into a plurality of local regions, and applying a third neural network to each of the local regions to extract a plurality of second-level features; segmenting the output of the first neural network into a plurality of patch regions greater than the number of local regions, and applying a fourth neural network to each of the patch regions to extract third-level features; performing feature combination by selecting features corresponding to a top certain percentage of the first-level features including high classification confidence values; performing feature combination by selecting features corresponding to a top certain percentage of the second-level features including high classification confidence values; selecting features corresponding to a top certain percentage of the third-level features including high classification confidence values and concatenating the selected features, and concatenating the selected and concatenated features of the first-level features, the selected and concatenated features of the second-level features, and the selected and concatenated features of the third-level features, inputting the concatenated features to a classifier, and classifying an emotion.

In some exemplary embodiments of the present disclosure, the method may further include providing the features selected from the first-level features and the features selected from the second-level features as input to the fourth neural network.

In some exemplary embodiments of the present disclosure, the segmenting of the output of the first neural network into the plurality of patch regions may include: performing up-sampling by applying a pixel shuffle to the output of the first neural network; and segmenting the up-sampled output into the plurality of patch regions.

According to the exemplary embodiments of the present disclosure, it is possible to extract global features, local features, and fine region features from an input image including a face by use of a plurality of different neural networks, and extract only features including discriminative power by use of the feature selector. A multi-scale module is applied to global features, so that deep contextual features and shallow geometric features may be considered together, to improve the diversity of features, and a comprehensive feature representation may be obtained even when the face is blocked or in various poses by reducing the sensitivity of deep convolutions. The attention may be applied to local and fine region features through an attentional module, especially the CBAM, to analyze fine facial details, and only the excellent features may be selected through the feature selector for global, local, and fine region features. Furthermore, as feature combination is performed by considering the association relationship, robust feature extraction is possible by identifying the association relationship between the features, and facial expression recognition with improved recognition performance may be realized. Furthermore, it is possible to minimize edge information loss through image up sampling by applying pixel shuffling, and to ensure robustness of edge information, and reduce memory usage and computation.

The methods and apparatuses of the present disclosure have other features and advantages which will be apparent from or are set forth in more detail in the accompanying drawings, which are incorporated herein, and the following Detailed Description, which together serve to explain certain principles of the present disclosure.

### BRIEF DESCRIPTION OF THE DRAWINGS

FIG. 1 is a block diagram illustrating a device for recognizing a facial expression of a vehicle occupant according to an exemplary embodiment of the present disclosure.

FIG. 2 and FIG. 3 are diagrams for illustrating an example of implementation of the device for recognizing the facial expression of the vehicle occupant according to the exemplary embodiment of the present disclosure.

FIG. 4, FIG. 5, FIG. 6 and FIG. 7 are diagrams illustrating examples of implementation of the device for recognizing the facial expression of the vehicle occupant according to the exemplary embodiment of the present disclosure.

FIG. 8 is a flowchart illustrating a method of recognizing a facial expression of a vehicle occupant according to an exemplary embodiment of the present disclosure.

FIG. 9 is a diagram illustrating a computing device according to an exemplary embodiment of the present disclosure.

It may be understood that the appended drawings are not necessarily to scale, presenting a somewhat simplified representation of various features illustrative of the basic principles of the present disclosure. The specific design features of the present disclosure as included herein, including, for example, specific dimensions, orientations, locations, and shapes locations, and shapes will be determined in part by the particularly intended application and use environment.

In the figures, reference numbers refer to the same or equivalent portions of the present disclosure throughout the several figures of the drawing.

### DETAILED DESCRIPTION

Reference will now be made in detail to various embodiments of the present disclosure(s), examples of which are illustrated in the accompanying drawings and described below. While the present disclosure(s) will be described in conjunction with exemplary embodiments of the present disclosure, it will be understood that the present description is not intended to limit the present disclosure(s) to those exemplary embodiments of the present disclosure. On the other hand, the present disclosure(s) is/are intended to cover not only the exemplary embodiments of the present disclosure, but also various alternatives, modifications, equivalents and other embodiments, which may be included within the spirit and scope of the present disclosure as defined by the appended claims.

Hereinafter, the present disclosure will be described more fully hereinafter with reference to the accompanying drawings, in which example embodiments of the present disclosure are shown. As those skilled in the art would realize, the described example embodiments may be modified in various different ways, all without departing from the spirit or scope of the present disclosure. Accordingly, the drawings and description are to be regarded as illustrative in nature and not restrictive. Like reference numerals designate like elements throughout the specification.

Throughout the specification and the claims, unless explicitly described to the contrary, the word “comprise”, and variations such as “comprises” or “comprising”, will be understood to imply the inclusion of stated elements but not the exclusion of any other elements. Terms including an ordinary number, such as first and second, are used for describing various constituent elements, but the constituent elements are not limited by the terms. The terms are used only to discriminate one constituent element from another constituent element.

Terms such as “part,” “unit,” “module,” and the like in the specification may refer to a unit configured for performing at least one function or operation described herein, which may be implemented in hardware or circuitry, software, or a combination of hardware or circuitry and software. Furthermore, at least some of the configurations or functions of a device and a method of recognizing a facial expression of a vehicle occupant according to example embodiments described below may be implemented as programs or software, and the programs or software may be stored on a computer-readable medium.

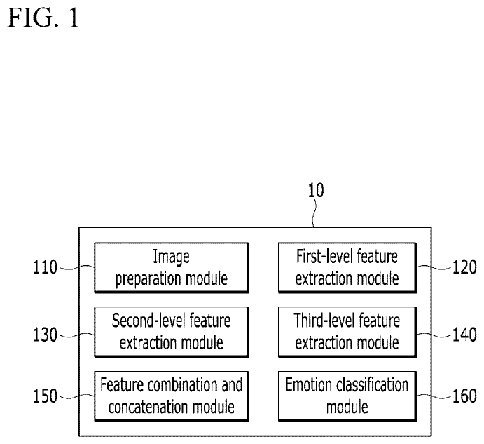

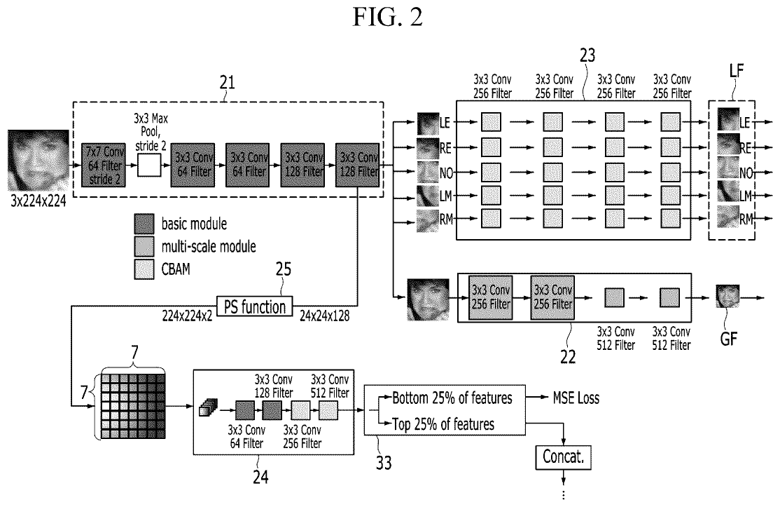

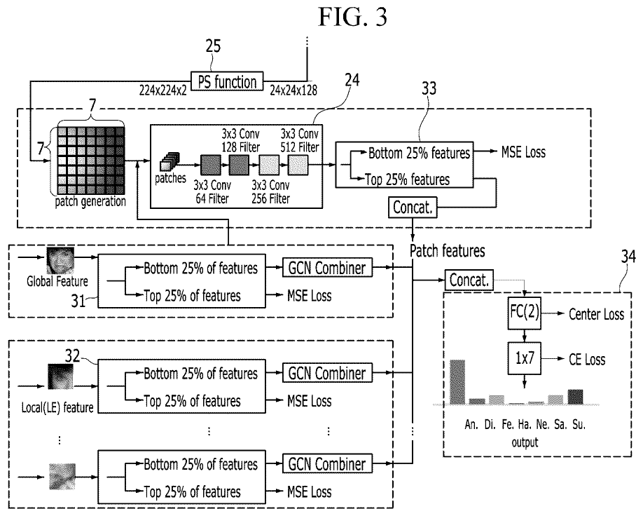

FIG. 1 is a block diagram illustrating a device for recognizing a facial expression of a vehicle occupant according to an example embodiment, and FIG. 2 and FIG. 3 are diagrams for illustrating an example of implementation of the device for recognizing the facial expression of the vehicle occupant according to the exemplary embodiment of the present disclosure.

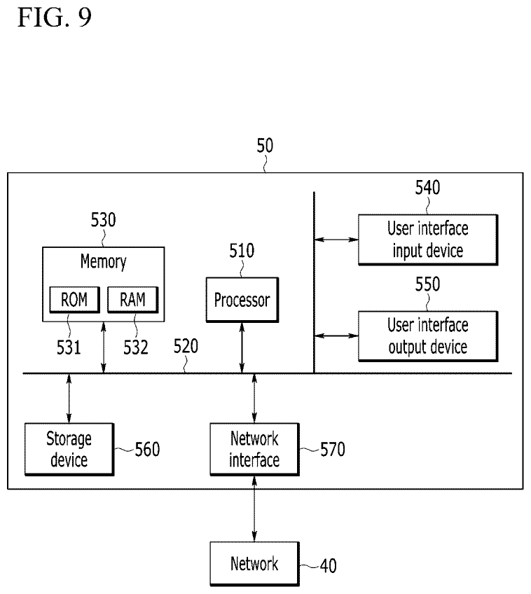

Referring to FIG. 1, a device 10 for recognizing a facial expression of a vehicle occupant according to an exemplary embodiment of the present disclosure may include one or more processors and one or more memory devices. For example, the device 10 for recognizing the facial expression may be implemented as a computing device 50, such as that described later with reference to FIG. 9. In the instant case, the one or more processors may correspond to a processor 510 of the computing device 50, and the one or more memory devices may correspond to a memory 520 of the computing device 50.

The one or more memory devices of the device 10 for recognizing the facial expression may include a program code executed by the one or more processors. The program code may be executed to recognize even partial and fine facial expressions and perform functions to improve emotion classification performance, and for clarity and convenience of description, these functions are described herein by use of the term “module”.

The device 10 for recognizing the facial expression may include an image preparation module 110, a first-level feature extraction module 120, a second-level feature extraction module 130, a third-level feature extraction module 140, a feature combination and concatenation module 150, and an emotion classification module 160. Referring to FIG. 2 and FIG. 3 together, the device 10 for recognizing the facial expression may use a plurality of neural networks 21, 22, 23, and 24 and a plurality of feature selectors 31, 32, and 33 to implement these elements.

The image preparation module 110 may prepare an input image that includes a facial region for performing facial expression recognition of a vehicle occupant. For example, the image preparation module 110 may obtain a still image or a video formed of a plurality of frames from a camera that captures a vehicle occupant in the vehicle. To the present end, a camera may be provided in the vehicle at a location which is suitable for capturing the vehicle occupant and does not interfere with driving. The vehicle occupant may be a driver, or may be an occupant who does not drive. In some exemplary embodiments of the present disclosure, individual cameras may be provided and operated for each vehicle occupant. For example, in a vehicle, one camera may be provided to capture the driver, another camera may be provided to capture an occupant in a front seat and not a driver's seat, and another camera may be provided adjacent to the rear seat to capture occupants on the rear seats. In some other exemplary embodiments of the present disclosure, a single camera may be provided to capture a plurality of vehicle occupants. The image preparation module 110 may detect a facial region to perform facial expression recognition in the obtained still image or video frame. That is, the image preparation module 110 may detect a facial portion of a vehicle occupant in the obtained still image or video frame and detect facial landmarks. For example, the image preparation module 110 may use a pose invariant point (PIP) neural network using a CNN-based structure to detect key facial landmarks in different poses, expressions, and lighting conditions. However, the image preparation module 110 may preprocess the obtained image based on the facial landmarks without using the facial landmarks detected by the PIP neural network for facial expression recognition.

The image preparation module 110 may output a face-aligned image from the image preprocessing. To align the facial regions, movement, rotation, scaling, tilting, and the like may be performed based on the facial landmarks. For example, the image preparation module 110 may detect a plurality of landmarks in the obtained image and select a few of the landmarks, such as a left eye, a right eye, a nose, a left portion of a mouth, and a right portion of a mouth. The image preparation module 110 may perform geometric transformations on the selected few landmarks to obtain a face-aligned image through a combination of movement, rotation, scaling, tilting, and the like. In some exemplary embodiments of the present disclosure, the image preparation module 110 may employ an affine transformation as the geometric transformation.

The image preparation module 110 may input the preprocessed, face-aligned input image to a first neural network 21 to obtain an output of the first neural network 21. The output of the first neural network 21 may then be transmitted to the first-level feature extraction module 120, the second-level feature extraction module 130, and the third-level feature extraction module 140.

The first neural network 21 may perform basic image processing prior to performing of the tasks by the first-level feature extraction module 120, the second-level feature extraction module 130, and the third-level feature extraction module 140. The first neural network 21 may include an initial layer and a residual block, and the initial layer and the residual block may include a plurality of basic modules. Herein, the basic module may refer to a general convolutional layer. Referring to FIG. 2 together, the first neural network 21 may include a convolutional layer and a pooling layer as initial layers. These initial layers may correspond to layers that begin feature extraction. The initial convolutional layer may correspond to a basic module, for example, a layer implemented as 7×7 convolution, 64 filter, and stride 2. The pooling layer may be a layer implemented with, for example, 3×3 max pooling and stride 2.

In the meantime, the first neural network 21 may include, following the initial layer, a plurality of residual blocks for learning the abstracted features. One residual block may include two basic blocks. The two basic blocks belonging to one residual block may include the same number of filters, but the number of filters in the basic block belonging to one residual block may be set to be different from the number of filters in the basic block belonging to the other residual block. Referring to FIG. 2 together, for example, a first residual block may include two basic modules implemented as 3×3 convolution, 64 filter, and stride 2, and a second residual block following the first residual block may include two basic modules implemented as 3×3 convolution, 128 filter, and stride 2.

As the image preparation module 110 employs the first neural network 21 that supports residual connectivity, the vanishing gradient problem may be avoided and the gradient may flow more easily through the neural network, improving learning efficiency and prediction performance.

The first-level feature extraction module 120 may apply a second neural network 22 to the output of the first neural network 21 to extract a first-level feature (GF). Here, the first-level feature (GF) is a feature extracted from the entire facial region among the results provided by the first neural network 21, which may be implemented as feature vectors, for example. The second neural network 22 may include a multi-scale module. The multi-scale module may capture spatial context from the image by use of multiple sized filters, rather than being limited to a single sized filter. That is, the second neural network 22 may include a plurality of multi-scale blocks including different sized filters. Each of the multi-scale blocks may extract features of different sizes for the input data. Referring to FIG. 2 together, for example, the second neural network 22 may include a first multi-scale block to a fourth multi-scale block in sequence. Herein, the first multiscale block and the second multiscale block are implemented as 3×3 convolution and 256 filter, and the third multiscale block and the fourth multiscale block are implemented as 3×3 convolution and 512 filter. The first-level feature GF may be extracted from the first multiscale block to the fourth multiscale block.

The second-level feature extraction module 130 may segment the output of the first neural network 21 into a plurality of local regions and apply a third neural network 23 to each of the local regions to extract a plurality of second-level features (LFs). Here, the second-level feature (GF) is a feature extracted from the partial facial region among the results provided by the first neural network 21, which may be implemented as feature vectors, for example. The third neural network 23 may include an attention module. The attention module may include a plurality of convolutional block attention modules (CBAMs). The CBAMs may include two types of attention mechanisms, a channel attention module and a spatial attention module, and may apply the channel attention module and the spatial attention module sequentially. In other words, a CBAM may first apply the channel attention, which learns the importance of each channel and adjusts the activation of each channel for each channel, and then apply the spatial attention, which learns the importance of each region of the image and adjusts the activation for each location for a result of the application of the channel attention. By adding the attention to the existing convolutional layer in the present way, the neural network may better focus on the important parts of the input image and improve the performance of the convolutional neural network. Referring to FIG. 2 together, the plurality of local regions may include, for example, a region including a left eye LE, a region including a right eye RE, a region including a nose NO, a region including a left portion of a mouth LM, and a region including a right portion of a mouth RM. In the meantime, for example, the third neural network 23 may include first, second, third and fourth CBAMs in sequence, and each of the first CBAM, the second CBAM, the third CBAM and the fourth CBAM may be implemented as a 3×3 convolution and 256 filter. The second-level feature LF may be extracted via the first CBAM, the second CBAM, the third CBAM and the fourth CBAM, each of which has as input the region including the left eye LE, the region including the right eye RE, the region including the nose NO, the region including the left portion of the mouth LM, and the region including the right portion of the mouth RM.

The third-level feature extraction module 140 may segment the output of the first neural network 21 into a plurality of patch regions and apply a fourth neural network 24 to each of the patch regions to extract a third-level feature. Here, the third-level feature is a feature extracted from the fine facial region among the results provided by the first neural network 21, which may be implemented as feature vectors, for example. Accordingly, the number of patch regions may be set to be greater than the number of local regions, since the patch regions are intended to take into account fine regions of the face. The fourth neural network 24 may include a patch attention module. The patch attention module may include a first basic module, a second basic module, a first CBAM, and a second CBAM that are sequentially connected for selecting a patch based on importance among the plurality of patch regions and performing feature extraction based on the patch. The number of filters in the first basic module, the second basic module, the first CBAM, and the second CBAM may all be set to increase as filters of different sizes. Referring to FIG. 2 together, for example, the patch region may be divided into 49 (7×7) regions, and the fourth neural network 24 may include a first basic module implemented as 3×3 convolution and 64 filter, a second basic module implemented as 3×3 convolution and 128 filter, a first CBAM implemented as 3×3 convolution and 256 filter, and a second CBAM implemented as 3×3 convolution and 512 filter. The third-level feature may be extracted from the first basic module, the second basic module, the first CBAM, and the second CBAM.

In some exemplary embodiments of the present disclosure, the output of the first neural network 21 may be transmitted to the third-level feature extraction module 140 via a pixel shuffle performing unit 25. The pixel shuffle performing unit 25 may perform up-sampling by applying a pixel shuffle to convert the output of the first neural network 21 into a high-resolution image. The pixel shuffle performing unit 25 may convert the output of the first neural network 21 to a high-resolution image by decreasing the number of channels corresponding to depth and increasing the spatial resolution (or spatial dimension) corresponding to width and height in the output of the first neural network 21. Therefore, it is possible to minimize the loss of edge information in the features and improve the robustness of the edge information. The third-level feature extraction module 140 may receive the up-sampled output and segment the received output into a plurality of patch regions.

The feature combination and concatenation module 150 may select the features that correspond to a top certain percentage of the first-level features GFs including with high classification confidence values and perform feature combining, to use only features with high importance or discriminative power. The feature combination and concatenation module 150 may input first-level features GFs corresponding to the output of the second neural network 22 to the global feature selector 31, and the global feature selector 31 may primarily select a predetermined number of features from the first-level features GFs. The feature combination and concatenation module 150 may secondarily select, among the selected features, features corresponding to a top certain percentage that are determined to have high classification confidence. Feature combining may be performed on the secondarily selected features by use of a graph convolutional network (GCN) combiner. For example, the feature combination and concatenation module 150 may construct a graph with nodes including feature vectors according to a result of the secondarily selection and edges representing association relationships between the nodes, combine the feature of each node with the features of the neighboring nodes, and generate a new feature representation of the center node based on the features of the neighboring nodes. Thus, the features of the nodes in the graph and the association relationships between the features may be learned. Referring to FIG. 3 together, for example, the global feature selector 31 may primarily select predetermined 12 features from the first-level features GFs and secondarily select features corresponding to the top 25% of features that are determined to have high classification confidence.

In some exemplary embodiments of the present disclosure, features corresponding to a bottom certain percentage of the first-level features GFs including low classification confidence values may be used as the mean squared error loss (MSE loss). The global feature selector 31 may primarily select a predetermined number of features from the first-level features GFs and use the features corresponding to a bottom certain percentage of the features that are determined to have low classification confidence among the primarily selected features as the MSE loss. Referring to FIG. 3 together, for example, the global feature selector 31 may primarily select predetermined 12 features from the first-level features GFs and use features corresponding to the bottom 25% of features that are determined to low classification confidence among the primarily selected features as the MSE loss.

Meanwhile, the feature combination and concatenation module 150 may perform feature combining by selecting features corresponding to a top certain percentage of the second-level features LFs including high classification confidence values. The feature combination and concatenation module 150 may input second-level features LFs corresponding to the output of the third neural network 23 to the local feature selector 32, and the local feature selector 32 may primarily select a predetermined number of features from the second-level features LFs. The feature combination and concatenation module 150 may secondarily select, among the selected features, features corresponding to a top certain percentage that are determined to have high classification confidence. For the secondarily selected features, feature combination may be performed by use of a graph convolutional network combiner. Referring to FIG. 3 together, for example, the local feature selector 32 may primarily select predetermined 12 features from the second-level features LFs and secondarily select features corresponding to the top 25% of features that are determined to have high classification confidence among the primarily selected features.

In some exemplary embodiments of the present disclosure, features corresponding to a bottom certain percentage including low classification confidence values among the second-level features LFs may be used as the MSE loss. The global feature selector 31 may primarily select a predetermined number of features from the second-level features LFs and use the features corresponding to a bottom certain percentage of the features that are determined to have low classification confidence among the primarily selected features as the MSE loss. Referring to FIG. 3 together, for example, the global feature selector 31 may primarily select predetermined 12 features from the second-level features LFs and use features corresponding to the bottom 25% of features that are determined to low classification confidence among the primarily selected features as the MSE loss.

Meanwhile, the feature combination and concatenation module 150 may perform concatenation by selecting features corresponding to a top certain percentage of the third-level features including high classification confidence values. The feature combination and concatenation module 150 may input third-level features corresponding to the output of the fourth neural network 24 to the fine region feature selector 33, and the fine region feature selector 33 may primarily select a predetermined number of features from the third-level features. The feature combination and concatenation module 150 may secondarily select, among the selected features, features corresponding to a top certain percentage that are determined to have high classification confidence. The concatenation may be performed on the secondarily selected features. Referring to FIG. 3 together, for example, the fine region feature selector 33 may primarily select predetermined 12 features from the third-level features and secondarily select features corresponding to the top 25% of features that are determined to have high classification confidence among the primarily selected features.

In some exemplary embodiments of the present disclosure, features corresponding to a bottom certain percentage including low classification confidence values among the third-level features may be used as the MSE loss. The fine region feature selector 33 may primarily select a predetermined number of features from the third-level features and use the features corresponding to a bottom certain percentage of the features that are determined to have low classification confidence among the primarily selected features as the MSE loss. Referring to FIG. 3 together, for example, the fine region feature selector 33 may primarily select predetermined 12 features from the third-level features and use the features corresponding to the bottom 25% of features that are determined to have low classification confidence among the primarily selected features as the MSE loss.

In some exemplary embodiments of the present disclosure, the selected features among the first-level features GFs and the selected features among the second-level features LFs may be provided as input to the fourth neural network 24. Referring to FIG. 3 together, the features corresponding to the top 25% of the features that are determined to have high classification confidence among the first-level features GFs and the second-level features LFs may be provided as input to the fourth neural network 24. Accordingly, among the fine regions of the face, the region that are considered to be more important or discriminative may be considered with high importance.

The feature combining and concatenation module 150 may concatenate the selected and combined features among the first-level features, the selected and combined features among the second-level features, and the selected and concatenated features among the third-level features, and transmit the concatenated features to the emotion classification module 160. The emotion classification module 160 may input the concatenated features of the selected and combined features among the first-level features, the selected and combined features among the second-level features, and the selected and concatenated features among the third-level features to the classifier 34 to classify the emotion. In some exemplary embodiments of the present disclosure, the emotion classification module 160 may classify the emotion into one of anger, disgust, fear, happiness, neutral, sadness, and surprise through a fully connected layer.

The emotions are classified from facial expression recognition of vehicle occupants, so that a variety of applications may be accomplished. For example, by detecting the driver's real-time facial expression changes, it is possible to continuously monitor whether the current emotional state is the state in which the driver is capable of performing safe driving. When it is detected that the driver is in an intense emotional state that threatens safety while driving, the vehicle control may be adjusted according to the detected driver's state to ensure safety. In another example, a user may be provided with personalized services based on his or her current real-time emotional state, such as content playing services which may reduce user's depression when the user is feeling down. In another example, when communicating with a vehicle using voice, the intent of the vehicle occupant's speech may be estimated by aggregating the results of speech content and facial expression recognition of the vehicle occupant, and customized services may be provided according to the estimated intent of the speech. When it is determined that the vehicle occupant is bored or annoyed based on the results of the speech content and facial expression recognition, multimedia content may be provided to relieve the boredom or annoyance of the vehicle occupant, or when it is determined that the vehicle occupant is curious about the cause of traffic congestion, information related to the predicted cause of traffic congestion and the traffic congestion section may be provided. As an exemplary embodiment of the present disclosure, a multimodal-based emotion recognition may be implemented by adding a result of tone recognition from the voice of the vehicle occupant and a result of biometric recognition, such as changes in heart rate, of the vehicle occupant to the result of the facial expression recognition of the vehicle occupant.

According to the present example embodiment, the global features, local features, and fine region features may be extracted from the input image including the face by use of a plurality of different neural networks, and only features including discriminative power may be extracted by use of the feature selector. A multi-scale module is applied to global features, so that deep contextual features and shallow geometric features may be considered together, to improve the diversity of features, and a comprehensive feature representation may be obtained even when the face is blocked or in various poses by reducing the sensitivity of deep convolution. The attention may be applied to local and fine region features through an attentional module, especially the CBAM, to analyze fine facial details, and only the excellent features may be selected through the feature selector for global, local, and fine region features. Furthermore, as feature combination is performed by considering the association relationship, robust feature extraction is possible by identifying the association relationship between the features, and facial expression recognition with improved recognition performance may be realized. Furthermore, it is possible to minimize edge information loss through image up sampling by applying pixel shuffling, and to ensure robustness of edge information, and reduce memory usage and computation.

In some exemplary embodiments of the present disclosure, features may be extracted from only the regions of the face that are determined to be necessary to improve recognition performance under various conditions determined by the specific facial expression recognition purpose, and emotion classification may be performed by aggregating only the result of the extracted features. For example, at least some of the first-level features, second-level features, and third-level features may be inactivated according to the facial expression recognition purposes, and only the remaining portion which is not inactivated may be combined and concatenated. In the instant case, the features corresponding to the top certain percentage of features for the remaining portion of the features including high classification confidence values may be selected and combined or concatenated to be input to the classifier 34 to classify the emotion.

For example, when the accuracy of facial expression recognition is very strictly required, first-level features related to the global region, second-level features related to the local region, and third-level features related to the fine region may all be used.

As an exemplary embodiment of the present disclosure, when computing resources are limited and a quick response is required, only first-level features related to the global region may be used, and in a case where only minute changes are desired to be observed, only third-level features related to the fine region may be used. Alternatively, in a case where a partial region of the face are blocked, such as a case where a user wears a mask, only second-level features for the local region including the eyes may be used.

In another example, in a measurement situation, only the first-level features related to the global region may be used in a case where the input pixels are large and the data is insufficient due to dark lighting or hardware limitations, and pixel shuffle may be actively utilized in a case where the image is blurry due to lens contamination, or only the features for the other regions that are determined to be accurate may be used when any of the global region, local region, and fine regions are determined to be inaccurate. As an exemplary embodiment of the present disclosure, for a measurement location in a vehicle, all of the first-level features related to the global region, the second-level features related to the local region, and the third-level features related to the fine region may be used for the driver, and only the first-level features related to the global region may be used for the occupant of the rear seat.

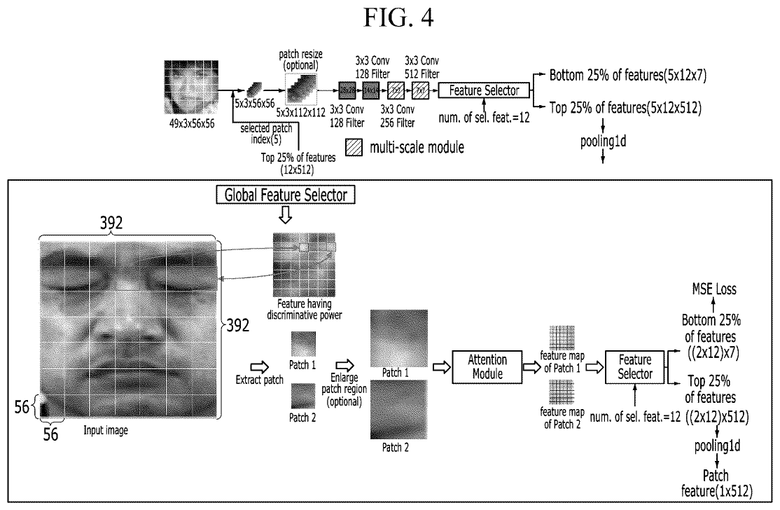

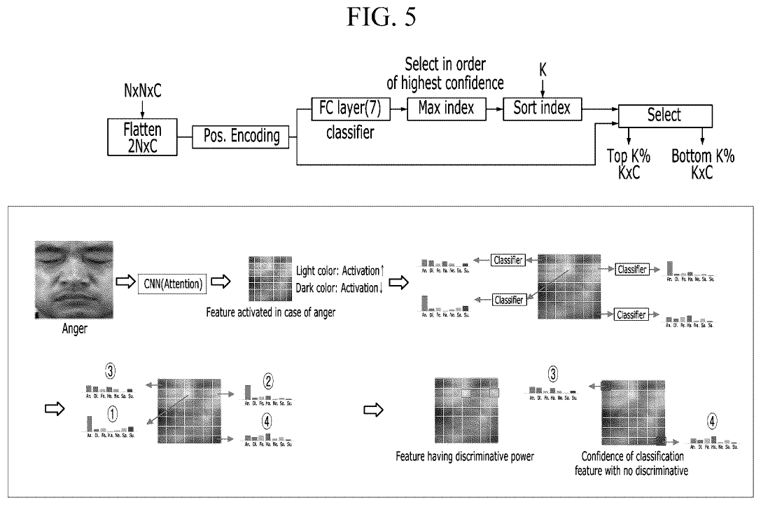

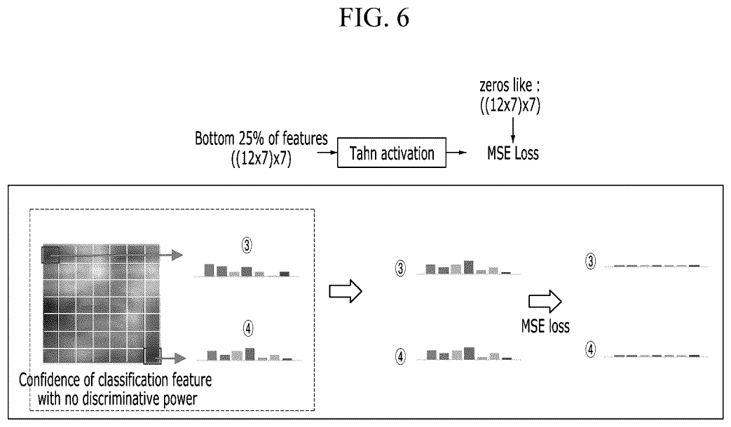

FIG. 4, FIG. 5, FIG. 6 and FIG. 7 are diagrams illustrating examples of implementation of the device for recognizing the facial expression of the vehicle occupant according to the exemplary embodiment of the present disclosure.

Referring to FIG. 4, the patch attentional module according to the exemplary embodiment of the present disclosure may once again observe minutely a location that the neural network is configured to determine to be important, and may include an example layer structure as illustrated. For example, when two features that are determined to be discriminative are selected by the global feature selector 31, a first patch Patch 1 and a second patch Patch 2 may be extracted, optionally enlarged, and input to the patch attentional module. Then, after a feature map for the first patch and a feature map for the second patch are constructed and transmitted to the fine region feature selector 33, the fine region feature selector 33 may primarily select a predetermined 12 features from the features, and secondarily select the features corresponding to the top 25% of the features determined to have high classification confidence among the primarily selected features, and the features corresponding to the bottom 25% of the features determined to have low classification confidence may be used as the MSE loss.

Referring to FIG. 5, the feature selector according to the exemplary embodiment of the present disclosure may select only significant feature regions from a feature map extracted via a neural network, and may include an example layer structure as illustrated. For example, in a feature map which is activated during a state of anger, lighter colors may correspond to great activation and darker colors may correspond to less activation. Here, features with great activation may represent features including discrimination power, and features with less activation may represent features including no discrimination power. Each feature region is input to the classifier and the classification is performed. Here, a classification confidence may be obtained for each class. Accordingly, the features including discriminative power with high classification confidence values are selected in order, and conversely, the features including no discriminative power with low classification confidence values may be selected in order. Accordingly, only the features with high classification confidence may be used and the other features may not be used. The features with low classification confidence may be used for MSE loss.

Referring to FIG. 6, the MSE loss according to the exemplary embodiment of the present disclosure may represent a loss function which may make the unnecessary region for the facial expression recognition and emotion classification in the facial region have further lower discriminative power. Furthermore, the loss function may make the features including discriminative power have more greater discriminative power.

Referring to FIG. 7, the graph convolutional network combiner according to the exemplary embodiment of the present disclosure may be used to combine features by recognizing association relationships within first-level features related to global regions, second-level features related to local regions, and third-level features related to fine regions based on an adaptive graph convolutional network (AGCN). For example, features selected from global features related to global regions correspond to nodes, and association relationships between the nodes are represented by edges and may be learned through training. Similarly, features selected from local features related to local regions correspond to nodes, and association relationships between the nodes are represented by edges and may be learned through training. The generated global features combined by the AGCN and the generated local features combined by the AGCN, respectively, may be combined by AGCN again to generate the final features.

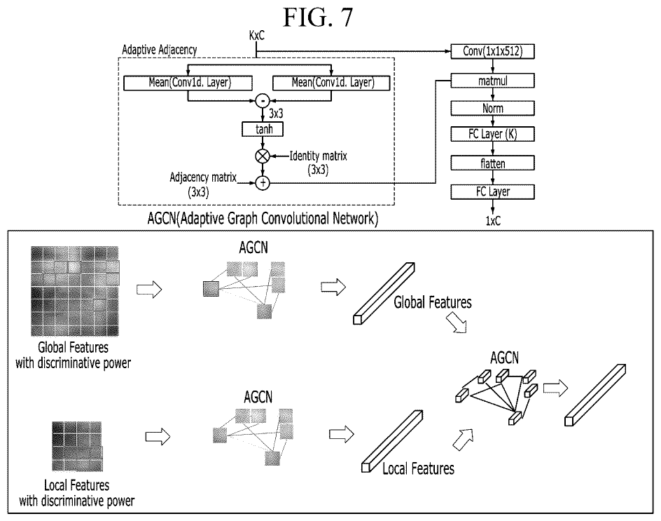

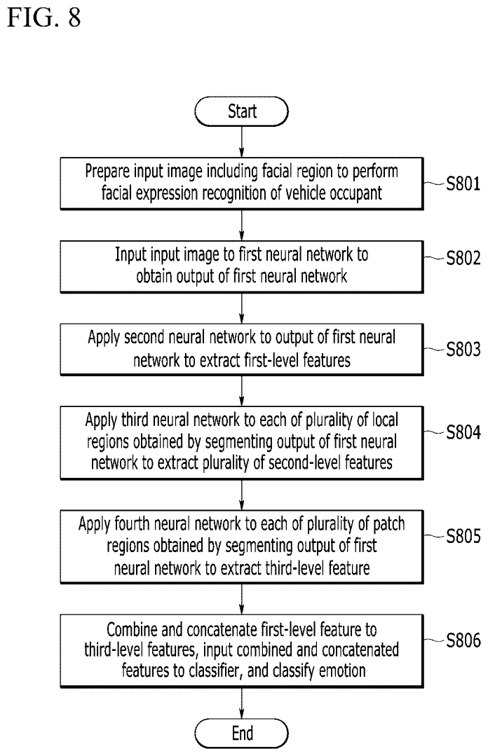

FIG. 8 is a flowchart illustrating a method of recognizing a facial expression of a vehicle occupant according to an exemplary embodiment of the present disclosure.

Referring to FIG. 8, a method of recognizing a facial expression of a vehicle occupant according to an exemplary embodiment of the present disclosure may include preparing an input image including a facial region to perform facial expression recognition of a vehicle occupant (S801), inputting the input image to a first neural network to obtain an output of the first neural network (S802), applying a second neural network to the output of the first neural network to extract first-level features (S803), applying a third neural network to each of local regions obtained by segmenting the output of the first neural network to extract a plurality of second-level features (S804), applying a fourth neural network to each of the patch regions obtained by segmenting the output of the first neural network to extract a third-level feature (S805), and combining and concatenating the first-level feature to the third-level features, inputting the combined and concatenated features to a classifier, and classifying the emotion (S806). For further details of the method, reference may be made to the description of the example embodiments described herein, so that duplicative descriptions are omitted herein.

FIG. 9 is a diagram illustrating a computing device according to an exemplary embodiment of the present disclosure.

Referring now to FIG. 9, the device and the method of recognizing the facial expression of the vehicle occupant according to the example embodiments may be implemented by use of a computing device 50.

The computing device 50 may include at least one of a processor 510, a memory 530, a user interface input device 540, a user interface output device 550, and a storage device 560 communicating via a bus 520. The computing device 50 may also include a network interface 570 electrically connected to the network 40. The network interface 570 may transmit or receive signals to or from other entities over the network 40.

The processor 510 may be implemented in various types, such as a micro controller unit (MCU), application processor (AP), a central processing unit (CPU), a graphic processing unit (GPU), a neutral processing unit (NPU), and a quantum processing unit (QPU), and may be a predetermined semiconductor device executing instructions stored in the memory 530 or the storage device 560. The processor 510 may be configured to implement the function and the methods described above with reference to FIG. 1, FIG. 2, FIG. 3, FIG. 4, FIG. 5, FIG. 6, FIG. 7, and FIG. 8.

The memory 530 and the storage device 560 may include various forms of volatile or non-volatile storage media. For example, the memory may include a read only memory (ROM) 531 and a random access memory (RAM) 532. In the example embodiment, the memory 530 may be located inside or outside the processor 510, and the memory 530 may be connected to the processor 510 through already known various means.

In some exemplary embodiments of the present disclosure, at least some configurations or functions of the device and the method of recognizing the facial expression of the vehicle occupant according to the example embodiments may be implemented as programs or software executed on the computing device 50, and the programs or software may be stored on a computer-readable medium. A computer-readable medium according to the exemplary embodiment of the present disclosure may record a program for executing the operations included in an implementation of the device and the method of recognizing the facial expression of the vehicle occupant according to the example embodiments on a computer including the processor 510 executing a program or instructions stored in the memory 530 or the storage device 560.

In some exemplary embodiments of the present disclosure, at least some configurations or functions of the device and the method of recognizing the facial expression of the vehicle occupant according to the example embodiments may be implemented using hardware or circuit of the computing device 50, or may be implemented as separate hardware or circuit that may be electrically connected to computing device 50.

According to the present example embodiment, the global features, local features, and fine region features may be extracted from the input image including the face by use of a plurality of different neural networks, and only features including discriminative power may be extracted by use of the feature selector. A multi-scale module is applied to global features, so that deep contextual features and shallow geometric features may be considered together, to improve the diversity of features, and a comprehensive feature representation may be obtained even when the face is blocked or in various poses by reducing the sensitivity of deep convolution. The attention may be applied to local and fine region features through an attentional module, especially the CBAM, to analyze fine facial details, and only the excellent features may be selected through the feature selector for global, local, and fine region features. Furthermore, as feature combination is performed by considering the association relationship, robust feature extraction is possible by identifying the association relationship between the features, and facial expression recognition with improved recognition performance may be realized. Furthermore, it is possible to minimize edge information loss through image up sampling by applying pixel shuffling, and to ensure robustness of edge information, and reduce memory usage and computation.

In various exemplary embodiments of the present disclosure, the memory and the processor may be provided as one chip, or provided as separate chips.

In various exemplary embodiments of the present disclosure, the scope of the present disclosure includes software or machine-executable commands (e.g., an operating system, an application, firmware, a program, etc.) for enabling operations according to the methods of various embodiments to be executed on an apparatus or a computer, a non-transitory computer-readable medium including such software or commands stored thereon and executable on the apparatus or the computer.

In various exemplary embodiments of the present disclosure, the control device may be implemented in a form of hardware or software, or may be implemented in a combination of hardware and software.

Furthermore, the terms such as “unit”, “module”, etc. included in the specification mean units for processing at least one function or operation, which may be implemented by hardware, software, or a combination thereof.

In the flowchart described with reference to the drawings, the flowchart may be performed by the controller or the processor. The order of operations in the flowchart may be changed, multiple operations may be merged, or any operation may be divided, and a specific operation may not be performed. Furthermore, the operations in the flowchart may be performed sequentially, but not necessarily performed sequentially. For example, the order of the operations may be changed, and at least two operations may be performed in parallel.

Hereinafter, the fact that pieces of hardware are coupled operably may include the fact that a direct and/or indirect connection between the pieces of hardware is established by wired and/or wirelessly.

In an exemplary embodiment of the present disclosure, the vehicle may be referred to as being based on a concept including various means of transportation. In some cases, the vehicle may be interpreted as being based on a concept including not only various means of land transportation, such as cars, motorcycles, trucks, and buses, that drive on roads but also various means of transportation such as airplanes, drones, ships, etc.

For convenience in explanation and accurate definition in the appended claims, the terms “upper”, “lower”, “inner”, “outer”, “up”, “down”, “upwards”, “downwards”, “front”, “rear”, “back”, “inside”, “outside”, “inwardly”, “outwardly”, “interior”, “exterior”, “internal”, “external”, “forwards”, and “backwards” are used to describe features of the exemplary embodiments with reference to the positions of such features as displayed in the figures. It will be further understood that the term “connect” or its derivatives refer both to direct and indirect connection.

The term “and/or” may include a combination of a plurality of related listed items or any of a plurality of related listed items. For example, “A and/or B” includes all three cases such as “A”, “B”, and “A and B”.

In exemplary embodiments of the present disclosure, “at least one of A and B” may refer to “at least one of A or B” or “at least one of combinations of at least one of A and B”. Furthermore, “one or more of A and B” may refer to “one or more of A or B” or “one or more of combinations of one or more of A and B”.

In the present specification, unless stated otherwise, a singular expression includes a plural expression unless the context clearly indicates otherwise.

In the exemplary embodiment of the present disclosure, it should be understood that a term such as “include” or “have” is directed to designate that the features, numbers, steps, operations, elements, parts, or combinations thereof described in the specification are present, and does not preclude the possibility of addition or presence of one or more other features, numbers, steps, operations, elements, parts, or combinations thereof.

According to an exemplary embodiment of the present disclosure, components may be combined with each other to be implemented as one, or some components may be omitted.

The foregoing descriptions of specific exemplary embodiments of the present disclosure have been presented for purposes of illustration and description. They are not intended to be exhaustive or to limit the present disclosure to the precise forms disclosed, and obviously many modifications and variations are possible in light of the above teachings. The exemplary embodiments were chosen and described to explain certain principles of the present disclosure and their practical application, to enable others skilled in the art to make and utilize various exemplary embodiments of the present disclosure, as well as various alternatives and modifications thereof. It is intended that the scope of the present disclosure be defined by the Claims appended hereto and their equivalents.

What is claimed is:

1. An apparatus for recognizing a facial expression of a vehicle occupant, the apparatus comprising:
one or more processors and one or more memory devices operably connected to the one or more processors,
wherein the one or more memory devices include a program code, and
wherein the program code is executed by the one or more processors to
prepare an input image including a facial region to perform facial expression recognition of the vehicle occupant,
input the input image to a first neural network including a plurality of basic modules including a residual block to obtain an output of the first neural network,
apply a second neural network to the output of the first neural network to extract first-level features,
segment the output of the first neural network into a plurality of local regions, and apply a third neural network to each of the local regions to extract a plurality of second-level features,
segment the output of the first neural network into a plurality of patch regions greater than a number of the local regions, and apply a fourth neural network to each of the patch regions to extract third-level features,
perform feature combination by selecting features corresponding to a top predetermined percentage of the first-level features including high classification confidence values,
perform feature combination by selecting features corresponding to a top predetermined percentage of the second-level features including high classification confidence values,
select features corresponding to a top predetermined percentage of the third-level features including high classification confidence values and concatenating the selected features, and
concatenate the selected and concatenated features of the first-level features, the selected and concatenated features of the second-level features, and
the selected and concatenated features of the third-level features, input the concatenated features of the first-level features, the second-level features and the third-level features to a classifier, and classify an emotion through the classifier, and
wherein the at least one processor includes the classifier.

2. The apparatus of claim 1, wherein the features selected from the first-level features and the features selected from the second-level features are provided as input to the fourth neural network.

3. The apparatus of claim 1,
wherein the first neural network includes an initial layer, and the plurality of residual blocks following the initial layer, and
wherein the residual block includes two the basic modules.

4. The apparatus of claim 1, wherein the second neural network includes a multi-scale module including a plurality of multi-scale blocks including filters of different sizes.

5. The apparatus of claim 1, wherein the third neural network includes a convolutional block attention module (CBAM) that includes a channel attention module and a spatial attention module, and sequentially applies the channel attention module and the spatial attention module.

6. The apparatus of claim 1, wherein the fourth neural network includes a patch attention module including a first basic module, a second basic module, a first CBAM, and a second CBAM which are sequentially connected.

7. The apparatus of claim 6,
wherein the first basic module is implemented as 3×3 convolution and 64 filter,
wherein the second basic module is implemented as 3×3 convolution and 128 filter,
wherein the first CBAM is implemented as 3×3 convolution and 256 filter, and
wherein the second CBAM has 3×3 convolution and 512 filter.

8. The apparatus of claim 1, wherein the segmenting of the output of the first neural network into the plurality of patch regions includes:
performing up-sampling by applying a pixel shuffle to the output of the first neural network; and
segmenting the up-sampled output into the plurality of patch regions.

9. The apparatus of claim 1, wherein features corresponding to a bottom predetermined percentage of the first-level features to the third-level features including low classification confidence values are used as mean squared error (MSE) loss.

10. The apparatus of claim 1, wherein the concatenation of the first-level features and the second-level features includes:
inputting each of the first-level features and the second-level features into a graph convolutional network (GCN) combiner, to perform feature combination.

11. The apparatus of claim 1, wherein the preparing of the input image including the facial region includes:
obtaining an image from a camera capturing the vehicle occupant;
detecting the facial region to perform the facial expression recognition in the image;
aligning the detected facial region; and
preparing a result of the aligning as the input image.

12. An apparatus for recognizing a facial expression of a vehicle occupant, the apparatus comprising:
one or more processors and one or more memory devices operably connected to the one or more processors,
wherein the one or more memory devices include a program code, and
wherein the program code is executed by the one or more processors to
prepare an input image including a facial region to perform facial expression recognition of the vehicle occupant,
input the input image to a first neural network including a plurality of basic modules including a residual block to obtain an output of the first neural network,
apply a second neural network to the output of the first neural network to extract first-level features,
segment the output of the first neural network into a plurality of local regions, and apply a third neural network to each of the local regions to extract a plurality of second-level features,
segment the output of the first neural network into a plurality of patch regions greater than a number of the local regions, and apply a fourth neural network to each of the patch regions to extract third-level features,
inactivate at least some of the first-level features, the second-level features, and the third-level features for the facial expression recognition, and
combine and concatenate a remaining portion of non-inactivated features, input the combined and concatenated remaining portion to a classifier, and classify an emotion through the classifier, and
wherein the at least one processor includes the classifier.

13. The apparatus of claim 12, wherein the classifying of the emotion includes:
selecting features corresponding to a top predetermined percentage of features of the remaining portion of the non-inactivated features including high classification confidence values, performing feature combination on the selected features or concatenating the selected features, inputting the combined or concatenated features to the classifier, and classify the emotion through the classifier.

14. The apparatus of claim 12, wherein the first neural network includes an initial layer, and the plurality of residual blocks following the initial layer, and the residual block includes two the basic modules.

15. The apparatus of claim 12, wherein the second neural network includes a multi-scale module including a plurality of multi-scale blocks including filters of different sizes.

16. The apparatus of claim 12, wherein the third neural network includes a convolutional block attention module (CBAM) that includes a channel attention module and a spatial attention module, and sequentially applies the channel attention module and the spatial attention module.

17. The apparatus of claim 12, wherein the fourth neural network includes a patch attention module including a first basic module, a second basic module, a first CBAM, and a second CBAM which are sequentially connected.

18. A method of recognizing a facial expression of a vehicle occupant, the method comprising:
preparing, by at least one processor, an input image including a facial region to perform facial expression recognition of the vehicle occupant;
inputting, by the at least one processor, the input image to a first neural network including a plurality of basic modules including a residual block to obtain an output of the first neural network;
applying, by the at least one processor, a second neural network to the output of the first neural network to extract first-level features;
segmenting, by the at least one processor, the output of the first neural network into a plurality of local regions, and applying a third neural network to each of the local regions to extract a plurality of second-level features;
segmenting, by the at least one processor, the output of the first neural network into a plurality of patch regions greater than a number of the local regions, and applying a fourth neural network to each of the patch regions to extract third-level features; performing, by the at least one processor, feature combination by selecting features corresponding to a top predetermined percentage of the first-level features including high classification confidence values;
performing, by the at least one processor, feature combination by selecting features corresponding to a top predetermined percentage of the second-level features including high classification confidence values;
selecting, by the at least one processor, features corresponding to a top predetermined percentage of the third-level features including high classification confidence values and concatenating the selected features, and
concatenating, by the at least one processor, the selected and concatenated features of the first-level features, the selected and concatenated features of the second-level features, and the selected and concatenated features of the third-level features, inputting the concatenated features of the first-level features, the second-level features and the third-level features to a classifier, and classifying, by the at least one processor, an emotion through the classifier,
wherein the at least one processor includes the classifier.

19. The method of claim 18, further including:
providing, by the at least one processor, the features selected from the first-level features and the features selected from the second-level features as input to the fourth neural network.

20. The method of claim 18, wherein the segmenting of the output of the first neural network into the plurality of patch regions includes:
performing, by the at least one processor, up-sampling by applying a pixel shuffle to the output of the first neural network; and
segmenting, by the at least one processor, the up-sampled output into the plurality of patch regions.
